(19) United States
(12) Patent Application Publication
(10) Pub. No.: US 2018/0240172 A1
(43) Pub. Date: Aug. 23, 2018

(54) VIRTUAL CONCIERGE SERVICE

(71) Applicants: Jason Barry, Bixby, OK (US); John Coffey, Bixby, OK (US)

(72) Inventors: Jason Barry, Bixby, OK (US); John Coffey, Bixby, OK (US)

(21) Appl. No.: 15/437,934

(22) Filed: Feb. 21, 2017

(51) Int. Cl. G06Q 30/06; G06F 17/30

(52) U.S. Cl. CPC G06Q 30/0613; G06Q 30/0625; G06F 17/30867

(57) ABSTRACT

A computer-implemented method for providing assertions in response to a goods and/or service item query is provided, the method comprising: as implemented by one or more computing devices configured with specific executable instructions, receiving usage data reflective of user activity on a virtual concierge service, the user activity comprising a plurality of queries for goods and/or service items offered for by the virtual concierge service; for a set of search criteria, determining an assertion based at least in part on the usage data, wherein the assertion is associated with a modified set of search criteria determined based at least in part on a user activity, wherein the user activity is reflective of user action taken in response to a query corresponding to the set of search criteria; receiving, from a user computing device, a query corresponding to the set of search criteria; transmitting the determined assertion to the user computing device; receiving selection of the assertion by the user computing device; automatically modifying the query in accordance with the modified set of search criteria; and transmitting results of the modified query to the user computing device.

### CROSS-REFERENCE TO RELATED APPLICATIONS

N/A

### BACKGROUND OF THE INVENTION

### 1. Field of the Invention

The present invention generally relates to Internet applications, and more particularly to a virtual concierge service enabling users to perform tasks remotely.

### 2. Description of Related Art

Gateway portals and computing networks are frequently accessed by users to obtain information and to make purchases. For example, a user may search for, review, and purchase needed supplies, services or any consumer goods by accessing a gateway portal. Furthermore, internet-based and/or network services and/or operating platform Virtual Concierge Services may enable a user to perform tasks at home or in the office and at the user's own convenience.

In some instances, Virtual Concierge Service may provide information regarding a variety of items offered from a variety of sources. Example, an internet-based and/or network services and/or operating platform (Virtual Concierge) using the virtual concierge for grocery services may offer grocery lists maintained with in the gateway portal, locations of grocery stores, preferred brands for purchase (Example Coke, Pepsi, Kraft, GE), personal grocery services (Personal Shopper, Personal Delivery, access to company platforms like Instacart), or other convince added value propositions to assist in shopping. Virtual Concierge has the ability to offer consumer services and consumer goods. The virtual concierge service may offer services like, Relocation buddy, a platform that helps customers with finding core everyday needed services for their home (Example Utilities provider, water provider, phone provider, TV provider, trash provider), by using many different methods from global fencing to contracts negotiated between the virtual concierge and the service provider via API and/or other means. Furthermore, the Virtual Concierge will include other offers such as information about and access to purchase everyday items (Example Insurance, Financial Products, Travel Products, Food, Drink, Clothing etc. . . . ) Virtual Concierge will have the ability to create partnerships with other platforms to better serve customers; those platforms include companies like Uber, Expedia, Instacart, Seat Geek, etc. Virtual Concierge will provide a platform to include purchases within the platform. Virtual Concierge will be the first system to aggregate API's from multiple vendors to service needs for customers along with building out its own proprietary platform to perform services requested.

### BRIEF SUMMARY OF THE INVENTION

In one embodiment of the present invention a computer-implemented method for providing assertions in response to a goods and/or service item query is provided, the method comprising: as implemented by one or more computing devices configured with specific executable instructions, receiving usage data reflective of user activity on a virtual concierge service, the user activity comprising a plurality of queries for goods and/or service items offered for by the virtual concierge service; for a set of search criteria, determining an assertion based at least in part on the usage data, wherein the assertion is associated with a modified set of search criteria determined based at least in part on a user activity, wherein the user activity is reflective of user action taken in response to a query corresponding to the set of search criteria; receiving, from a user computing device, a query corresponding to the set of search criteria; transmitting the determined assertion to the user computing device; receiving selection of the assertion by the user computing device; automatically modifying the query in accordance with the modified set of search criteria; and transmitting results of the modified query to the user computing device.

In one embodiment, a goods and/or service item corresponds to at least one virtual concierge service. In another embodiment, the user activity corresponds to at least one of searching for goods and/or service items or acquiring a goods and/or service item. In one embodiment, modifying the query in accordance with the modified set of search criteria comprising modifying at least one of a package to be selected, a service location, a specific brand, a number of items purchased, a number of users, a preferred level of service, and a preferred provider of the goods and/or service item. In yet another embodiment, the determined assertion is further associated with a categorization of the user activity. In one embodiment, the categorization of the user activity corresponds to at least one of business or personal.

In another aspect to the invention a system for providing assertions regarding an item query is provided, the system comprising: at least one data store configured to store assertions, wherein each assertion is associated with a set of search criteria and with a modification of the set of search criteria determined based at least in part on a user activity, and wherein the user activity is reflective of user action taken in response to a query corresponding to the set of search criteria; and one or more processors in communication with the at least one data store, the one or more processors configured to: receive, from a user computing device, a query including search criteria; and determine one or more of the assertions corresponding to the query based at least in part on the search criteria; wherein user selection of the determined one or more assertions enables modification of the query based at least in part on the modification associated with the assertion.

In one embodiment, the one or more processors are further configured to transmit the determined one or more assertions to the user computing device. In another embodiment, the query corresponds to a query for one or more goods and/or service items. In one embodiment, each of the determined one or more assertions are further associated with a categorization of the user activity corresponding to the assertion. In yet another embodiment, the one or more processors are further configured to determine a categorization of the query based at least in part on the search criteria. In another embodiment, the determination of one or more of the assertions corresponding to the query is further based at least in part on the determined categorization of the query. In one embodiment, the categorization of the query is further based at least in part on at least one of past activity of the user computing device, a user profile associated with the user computing device, or purchase history of a user associated with the user computing device. In one embodiment, the user activity corresponds to at least one of searching for an item or acquiring an item. In another embodiment, the one or more processors are further configured to determine additional information regarding items corresponding to the one or more assertions. In yet another embodiment, the additional information comprises at least one of an average price of the items corresponding to the one or more assertions, a lowest price of an item corresponding to the one or more assertions, and a difference in price between an item corresponding to the one or more assertions and an item corresponding to the received query.

In another aspect to the invention a non-transitory computer-readable storage medium having at least one computer-executable module for providing assertions regarding an item query, the at least one computer-executable module is provided, comprising: an assertion module configured to: maintain one or more assertions, wherein each assertion is associated with set of search criteria and with a modification of the set of search criteria determined based at least in part on a user activity, and wherein the user activity is reflective of user action taken in response to a query corresponding to the set of search criteria; determine a query including search criteria based at least in part on activity of a user computing device; determine at least one of the one or more assertions corresponding to the query based at least in part on the search criteria; and transmit the determined at least one assertion to the user computing device; wherein user selection of the determined at least one assertion enables modification of the query based at least in part on the modification associated with the assertion.

In one embodiment, the user activity of each of the one or more assertions corresponds to activity of a contact of the user associated with the user computing device, and wherein the contact corresponds to at least one of a contact on a virtual concierge service, a contact on a social networking service, or a contact within an address book of the user associated with the user computing device. In another embodiment, the assertion module is further configured to generate the one or more assertions based on received usage data, and wherein the usage data reflects activity of users taken in response to a query corresponding to the set of search criteria. In another embodiment, generation of the one or more assertions comprises a determination of a user activity conducted by users a threshold number of times. In yet another embodiment, generation of the one or more assertions comprises a determination of a user activity conducted by at least a threshold percentage of users in response to a query corresponding to the set of search criteria.

In another aspect to the invention, a computer-implemented method for providing assertions regarding an item query is provided, the method comprising: as implemented by one or more computing devices configured with specific executable instructions, determining one or more assertions, wherein each assertion is associated with set of search criteria and with a modification of the set of search criteria determined based at least in part on a user activity, and wherein the user activity is taken in response to a query corresponding to the set of search criteria; determine a query including search criteria based at least in part on activity of a user computing device; and determining at least one of the one or more assertions corresponding to the query based at least in part on the search criteria; wherein user selection of the determined at least one assertion enables modification of the query based at least in part on the modification associated with the assertion.

In one embodiment, determining at least one of the one or more assertions corresponding to the query further comprising determining a prioritization of the one or more assertions corresponding to the query. In one embodiment, wherein determining one or more assertions is based at least in part on usage data reflective of activities of users taken in response to a query corresponding to the set of search criteria. In another embodiment, the invention further comprises transmitting the determined one or more assertions to the user computing device. In yet another embodiment, the determined query is at least one of an explicit query and an inferred query.

Such stated summary and advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a block diagram illustrating an operating environment for a virtual concierge service according to an embodiment of the present invention.

FIG. 2 is an illustrative interaction for providing relevant assertions to a user gateway portal in response to a search query according to an embodiment of the present invention.

FIG. 3 is an illustrative interaction for submission of a search queries by user gateway portal to the concierge service, and for categorization of such search queries by the usage monitoring module according to an embodiment of the present invention.

FIG. 4 is an illustrative interaction for generation of assertions based on usage information within the usage information data store according to an embodiment of the present invention.

FIG. 5 is a block diagram illustrating an operating environment for a virtual concierge service grocery cart according to an embodiment of the present invention.

### DETAILED DESCRIPTION OF THE PREFERRED EMBODIMENT

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein to specifically provide a virtual concierge service.

An internet-based and/or network service and/or operating platform, up to and including mobile apps, personal computers, tablets, phones and/or any device that can access the internet that may be provided for facilitating queries for a number of items, such, A user may submit a query looking for one or more services and/or items that may be purchased, consumed, delivered and/or provided. Based on the submitted query, the internet-based and/or network service and/or operating platform may present the user with information regarding the services to be purchased, consumed, delivered and/or provided. The internet-based and/or network service can be accessed via web, app, text messaging, phone call, voice recognition. Web, apps, text messaging, phones, personal computers may be referenced as gateway portals. Moving forward any internet-based and/or network service and/or operating platform, up to and including mobile apps, personal computers, tablets, phones and/or any device that can access the internet that may be provided for facilitating queries for a number of items may be referred to as Virtual Concierge Service or “VCS”.

Generally described, aspects of the present invention are directed to managing queries for items offered or provided via internet-based and/or network services and/or operating platform (Virtual Concierge) services. More specifically, aspects of the present invention relate to facilitating the generation of new search queries based on a current query as well as on other queries or information submitted to an internet-based and/or network services and/or operating platform (Virtual Concierge) service. Illustratively, an internet-based and/or network services and/or operating platform (Virtual Concierge) service may offer one or more items for purchase or services provided. In one embodiment, an internet-based and/or network services and/or operating platform (Virtual Concierge) service may correspond to a service offering utilities, cable, satellite, groceries, travel, financial products, entertainment, dining, insurance, any and all basic purchasable or consumable products etc. A user of the internet-based and/or network services and/or operating platform (Virtual Concierge) service may submit a query including criteria for selecting one or more relevant items (Example local grocery store, local utility company, satellite vs. cable provider etc. . . . ). Thereafter, the service may return any available and relevant items.

In addition, the service may return information for facilitating supplementation, expansion, or replacement of the query. Such information may be generated, for example, based on other queries submitted to the internet-based and/or network services and/or operating platform (Virtual Concierge) service (Example, by users within the local area as well as worldwide), based on previous, purchases, services orders or inquiry of items on the internet-based and/or network services and/or operating platform (Virtual Concierge) service, based on information regarding the querying user, based on other additional or alternative information, or any combination thereof.

Illustratively, a user of an internet-based and/or network services and/or operating platform (Virtual Concierge) Example, a service that provides information regarding available price packages for television service may submit a query for a package A vs. a package B. Thereafter, relevant packages may be returned to the user for selection. However, in some instances, the number of packages matching the user's criteria may not be offered or exactly matched to the criteria and therefore the internet-based and/or network services and/or operating platform (Virtual Concierge) may not be able to provide information regarding the exact or similar package. Further, even when a package is found a number of relevant add-ons (Example HD channels, Pay Channels, Sports Channels etc.) may be presented to the user, the user may not decide to or be unable to select the most preferred package from the presented packages. Accordingly, it may be desirable to enable to user to further refine, alter, or replace the current query. For example, a user may be presented with the option to view only packages with a set contract term versus options with no contract term. Alternatively, a user may be presented with the option to view services with or without leasing hardware. (Example . . . obtains a package with no contract). In some embodiments, presentation of additional or alternative query options may be in the form of recommendations or suggestions. In other embodiments, presentation of query options may be in the form of a statement or assertion. For example, a user may be notified that “most customers using said service chose Package A over Package B by 50%, as well as 90% of customers leased hardware.” Accordingly, the user may be enabled to select the recommendation or assertion to further refine, alter, or replace the current query. For example, by the selection of the above assertion, the user may be enabled to view only lease packages matching the user's criteria. Accordingly, the user may be enabled to better select a relevant item from among a large number of potentially relevant items.

In other embodiments, information provided to a user may enable the user to expand search results for available items. For example, a user may again submit a query for a package. However, unbeknownst to the user, a more desirable package may be available incorporating a bundle (Example, adding phone service and/or internet service, etc.) Because the user's query criteria did not include a bundle, the user may not initially be aware of these other packages. However, other users of virtual concierge service may have discovered and purchased these alternative packages. Therefore, by presenting a querying user with information regarding popular selected packages of other users, the querying user may be more able to ascertain the available of desirable packages. Accordingly, the user may be enabled to expand or replace an initial query based on information of other users of the virtual concierge service.

In other embodiments, assertions may be personalized to a particular user. For example, assertions may include information regarding actions of one or more contacts (Example, contacts on a social networking system, contacts of a mobile device or cellular telephone, etc.). For example, a user may search for packages without a bundle and in return, be presented with analysis that a majority of their contacts instead purchased a bundle.

As noted above, assertions may be based on previous purchases or services provided. Purchase of items on the internet-based and/or network services and/or operating platform (Virtual Concierge) service, based at least in part on information regarding the querying user, based on other additional or alternative information, or any combination thereof For example, in some embodiments, assertions may be based on all other users conducting the same or similar query as a querying user. Illustratively, where a user searches for bundled, lease packages, presented assertions may be based on all queries (Example, queries by other users or prior queries by the current user) for all packages unbundled vs bundles and/or leased vs non-leased packages. By analyzing these corresponding queries, commonalities may be determined for inclusion in an assertion. For example, in some embodiments, the most frequent actions taken by customers during similar queries may be presented to a user. By way of illustration, when analyzing the similar queries for Packages A to Packages B, virtual concierge service may determine that: 90% of users selected Package A; 10% Package B of those Packages 90% of users booked a leased package; and 10% of users booked a non-leased package. Accordingly, users may be enabled to modify or replace their current query with a query conforming to the above determined similarities. Illustratively, upon seeing that 90% of users booked Package A, a querying user may elect to view Package A options. In some embodiments, only the most significant information may be presented to a querying user. For example, only the highest selected actions (Example, as determined by a percentage or numbers of users taking the action) may be presented to a user. Alternatively, only actions above a threshold number or percent of users may be presented (Example, actions taken by more than 50% of users, actions taken by more than half of all users that have purchased, etc.).

Still further, in some embodiments, similar queries may be selected based on information associated with the querying user, such as a query category. Illustratively, a query may be placed into a number of categories, such as “business contract,” “personal contract,” “government contract,” “affiliate contract,” etc. As will be described in more detail below, a query category may be based on the user's current query or past queries, the user's profile, the user's past action on the concierge service or other services, or any combination thereof.

In instances where a query is determined to be of a specific category of queries, assertions presented to the user may be determined based on actions of other queries corresponding to the category. For example, A business contract for a sports restaurant and/or bar, the user may be presented with information specifying that, of other sports restaurant and/or bars querying for similar packages, 95% used, purchased and/or preferred one package over another. Similarly, where a personal contract user queries for the same or similar packages, the user may be presented with information specifying that, of the personal contract users querying for the same or similar packages, 80% selected a certain or particular package. By presenting information determined based on other similar users, each user may be presented with assertions most relevant to their query.

By presentation of assertions reflecting activity of other users, a querying user may be enabled to recreate such packages, discounts, bundles etc. . . . . For example, a package taken by a large proportion of similar users may indicate benefits of that package which are not otherwise readily apparent. For example, pricing for package items may vary widely based on the type of use of the package.

Though described herein with respect to specific types of services, embodiments of the present invention may be applied to any purchasable goods, services, offers and/or needs a consumer may want, including but not limited to household services, entertainment, groceries, dining, travel, etc. . . . Moreover, aspects of the present invention may be applied with respect to other item queries, and should not be construed to be limited to one particular service unless explicitly stated otherwise.

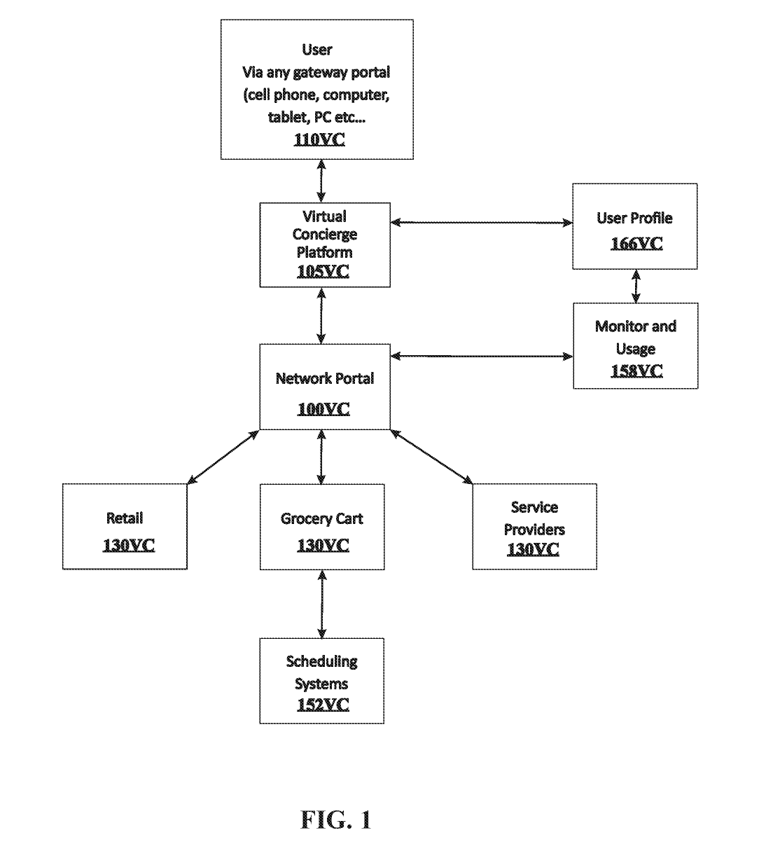

Moreover, though illustrative examples are provided herein with regard to a specific user queries, in some embodiments, assertions may be provided based on an inferred user query or interest. For example, user looking at Personal Package A. Based on such activity, it may be inferred that a user would be interested in bundled services including phone, internet security etc. . . . . Based on this inference, assertions regarding a query for Personal Package A, a bundled package may be presented to the user. FIG. 1 is a block diagram depicting an illustrative operating environment in which an internet-based and/or network services and/or operating platform (Virtual Concierge) concierge service 105VC enables customers to browse, search for, and acquire goods and services items made available by third party providers or the operator of the goods and/or service 130VC. As illustrated in FIG. 1, the operating environment includes one or more buying services (direct or API) 130VC and one or more gateway portal devices 110VC in communication with an internet-based and/or network services and/or operating platform (Virtual Concierge) service 105VC via a network of third party providers or the operator of the goods and/or service 130VC. A third party provider, using a booking or reservation system, may make goods and/or service items, or information regarding goods and/or service items, available to the concierge service 105VC via the network portal 100VC. The goods and/or service provider 130VC may then make the goods and/or service, as well as other goods and/or services, available to the user's gateway portal 110VC. Accordingly, a user, using a gateway portal device 110VC, may browse the goods and/or service items available from the internet-based and/or network services and/or operating platform (Virtual Concierge) service 105VC, search for goods and/or service items, and acquire, use, or schedule one or more desired goods and/or service items.

A user's gateway portal device 110VC may be any computing device, such Web, apps, text messaging, phones, personal computers, and the like. The internet-based and/or network services and/or operating platform (Virtual Concierge) service 105VC and the user's gateway portal devices 110VC may communicate with the concierge service via a network portal 100VC. The network portal 100VC may be any wired network, wireless network or combination thereof. In addition, the network portal 100VC may be a personal area network, local area network, wide area network, cable network, satellite network, cellular telephone network, or combination thereof. In the illustrated embodiment, the network 100VC is the Internet. Protocols and components for communicating via the Internet or any of the other aforementioned types of communication networks are well known to those skilled in the art of computer communications and thus, need not be described in more detail herein.

The concierge purchasing systems via the internet-based and/or network services and/or operating platform (Virtual Concierge) service 105VC may correspond to any systems or devices configured or enabled to allow purchasing, using, acquiring, ordering etc. . . . . For example, a concierge purchasing system within the internet-based and/or network services and/or operating platform (Virtual Concierge) service 105VC may correspond to a centralized purchasing system, a global distribution system, or any other system where multiple services and/or goods item providers 130VC, such as television providers 130VC, grocery stores 130VC, restaurants 130VC, financial institutions 130VC, hotels 130VC, etc., make goods and/or service items available for purchase, use, lease etc. . . . . In other embodiments, a purchase system the internet-based and/or network services and/or operating platform (Virtual Concierge) service 105VC may correspond to a system provided by an individual goods and/or service item provider (Example, a specific television provider, grocery store, restaurant chain, financial institutions, hotel chains, etc.). In general, each purchase system may enable other internet-based and/or network services and/or operating platform (Virtual Concierge) devices, such as devices of the concierge service 105VC to request information regarding goods and/or service items (Example, available inventory, price, installation, etc.), to search goods and/or service items, and to purchase, request, and/or lease goods and/or services. Operation of purchase systems is well known within the art, and therefore will not be described in more detail herein.

In the illustrated embodiment, the concierge service 105VC is illustrated as a computer environment including several computer systems that are interconnected using one or more networks. More specifically, the internet-based and/or network services and/or operating platform (Virtual Concierge) service 105VC may include a user a scheduling systems interface module 152VC, a usage monitoring module 158VC, as well as usage information data store 158VC, a user profile data store 166VC, and an assertion data store. However, it will be appreciated by those skilled in the art that the internet-based and/or network services and/or operating platform (Virtual Concierge) service 105VC could have fewer or greater components than are illustrated in FIG. 1. In addition, the internet-based and/or network services and/or operating platform (Virtual Concierge) service 105VC could include various Web services and/or peer-to-peer network configurations. Additionally, in some embodiments, the concierge service may be implemented by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. Thus, the depiction of the internet-based and/or network services and/or operating platform (Virtual Concierge) service 105VC in FIG. 1 should be taken as illustrative and not limiting to the present invention.

The internet-based and/or network services and/or operating platform (Virtual Concierge) 105VC may facilitate interaction with the purchasing, scheduling systems 152VC, including searching for relevant goods and/or service items, retrieving information regarding goods and/or service items, and purchasing, using, leasing good and/or service items. In some embodiments, multiple goods and/or service system interface modules 130VC may be provided, each configured to interact with one or more specific systems. For example, a first goods and/or service system interface module 152VC may interact with a television provider system 130VC, while second goods and/or service systems interface module may interact with an internet provider based system 110VC.

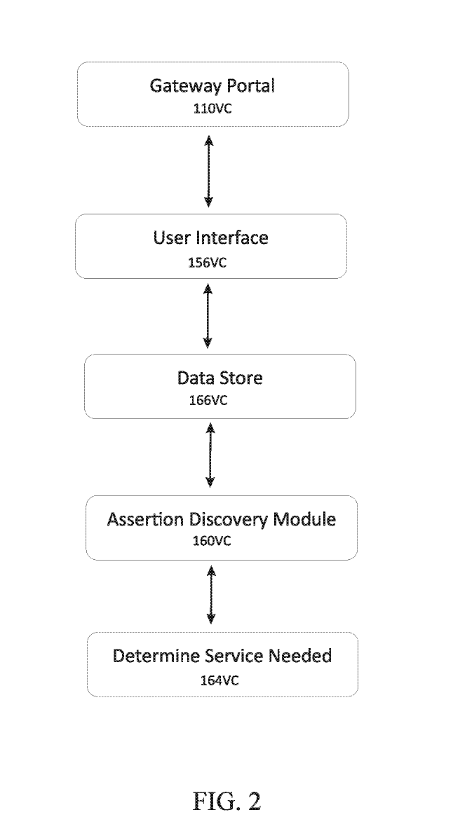

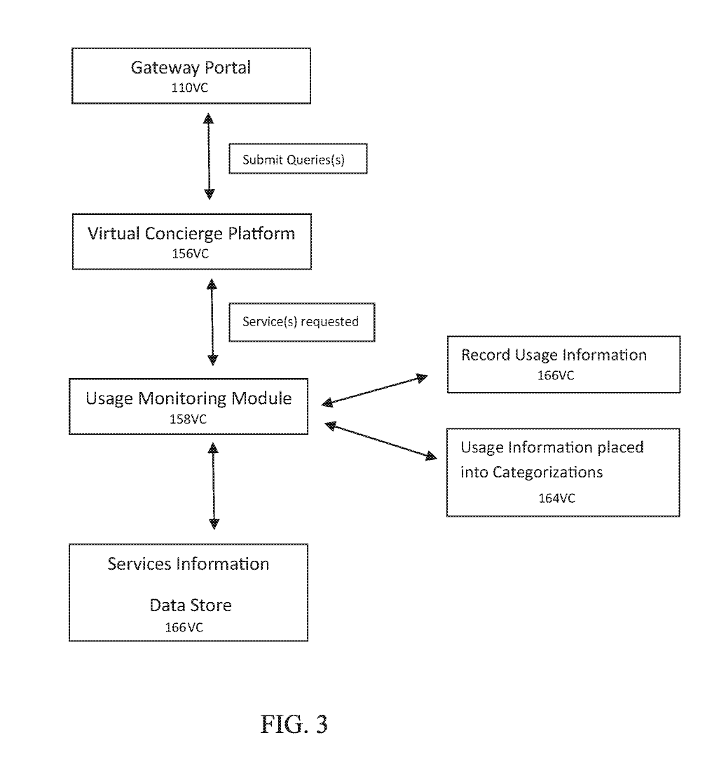

The user interface module may facilitate searching, browsing, and purchase (Example, by scheduling, reserving, etc.) of goods and/or service items by users via user's gateway portal 110VC (computing devices). In some embodiments, the user gateway portal module 110VC may include a web server for generation of webpages facilitating such searching, browsing, and purchase. Examples of a user interfaces that may be generated by a user interface module 156VC will be described in more detail in FIGS. 2-3, below.

The user interface module 156VC may further be configured to store, maintain, and acquire information from a user profile data store 166VC. The user information data store 166VC may correspond to any persistent or substantially persistent data store, such as one or more hard disk drives (HDDs), solid state drives (SSDs), or network attached storage devices (NASs). The user profile data store 166VC may store information regarding users, such as a user's name, age, address, date of birth, credit card information, purchase history, preferences, demographics, important dates (birthday, anniversary, etc.) etc.

Still further, the user interface module 156VC may interact with the usage monitoring module 158VC FIG. 1. to store usage information of user computing devices 110VC regarding the internet-based and/or network services and/or operating platform (Virtual Concierge) service 105VC. For example, the user interface module 156VC may transmit information regarding searching, viewing, and purchase of goods and/or service items by users to the usage monitoring module 158VC FIG. 1. The usage monitoring module 158VC FIG. 1 may transform or otherwise process the information for storage in a data store 166VC, such information may determine services needed 164VC. Illustratively, transformation of the usage information may include masking of usage information (Example, by removal of sensitive or personal information, such as name, address, etc.) or compression of usage information. As will be described in more detail below with respect to FIG. 3, in some embodiments, the usage monitoring module 158VC may further be configured to categorize usage information 166VC into a number of relevant categories. For example, a first subset of usage information may be categorized as “business” activities, while a second subset of usage information may be categorized as “personal” activities. After processing of usage information 164VC, the usage information (along with any corresponding categorization information) may be stored within the usage information data store 166VC. Similarly, to the user profile data store 166VC described above, the usage information data store 164VC may correspond to any persistent or substantially persistent data store, such as one or more hard disk drives (HDDs), solid state drives (SSDs), or network attached storage devices (NASs).

The concierge service 105VC FIG. 1 may further include an assertion discovery module 160VC FIG. 2 configured to determine assertions relevant to a search query, and to retrieve relevant assertions in response to such query. As will be described below, these assertions may be determined based at least in part on usage information (Example, as stored within the usage information data store 164VC FIG. 3). Generated assertions may reflect relevant activities taken by other users of the concierge service 105VC, such as a type of goods and/or service item purchased, or specific search terms utilized. For example, an assertion may reflect that, of users searching for television providers 90% chose a bundled package. Accordingly, by reviewing the activities of other users, a user searching for a good and/or service according to the criteria described above may be enabled to discover queries utilized by other users, and recreate such queries quickly. Because an activity taken by a significant number of similar users is likely also to benefit the querying user, the presentation of assertions allowing re-creation of the specific activity may be of benefit to end users.

After generation of assertions, the assertion discovery module 160VC FIG. 2 may store assertions for later retrieval, such as in a data store 166VC FIG. 2. Similarly, to the data stores described above, the assertion data store 166VC FIG. 2 may correspond to any persistent or substantially persistent data store, such as one or more hard disk drives (HDDs), solid state drives (SSDs), and network attached storage devices (NASs).

Though not shown in FIG. 1, in some embodiments, the concierge service 105VC FIG. 1 may include additional or alternative components for interaction with one or more external services, such as social network services. Illustratively, such components may gather information identifying one or more contacts of the user (Example, for use in determining relevant assertions). Still further, the concierge service 105VC FIG. 1 may include additional or alternative components to determine contacts of the user based at least in part on an address book of the user computing device. Because interaction with social networking systems and address books of user's devices are well known within the art, these interactions will not be discussed in detail herein.

With reference to FIGS. 2-3, illustrative interactions for providing assertions based on a query including search criteria will be described. Specifically, with respect to FIG. 3, an illustrative interaction for submission of a search queries by user gateway portal 110VC to the concierge service 156VC, and for categorization of such search queries by the usage monitoring module 158VC will be described. With respect to FIG. 3, an illustrative interaction for generation of assertions based on submitted search queries as well as other user activity (Example, purchase, scheduling, or booking of goods and/or service items) will be described. With respect to FIG. 2, an illustrative interaction for providing relevant assertions to a user gateway portal 110VC in response to a search query will be described.

With reference now to FIG. 3, at (1), one or more user gateway portal's 110VC may submit goods and/or service queries to the virtual concierge platform 156VC. For example, a television provider query may correspond to search criteria for location of one or more television provider items desired by a user gateway portal 110VC. For example, a television provider query may correspond to a query for television, phone service, internet, security, etc. Illustratively, the virtual concierge platform 156VC may be configured to locate one or more goods and/or service items (Example, by interaction with the scheduling systems interface module 152VC FIG. 1 to return relevant goods and/or service items to the gateway portal 110VC. Because querying for television provider items is generally known within the art, the specific interaction for returning relevant goods and/or service items will not be discussed in more detail herein.

In accordance with embodiments of the present invention, usage information generated by or in response to user gateway portal 110VC may, at (2), be submitted to the usage monitoring module 158VC. Illustratively, usage information may correspond to the specific search criteria submitted within a user query. Still further, usage information may correspond to other activities of the user computing gateway portal 110VC, such as purchase of goods and/or service items (Example, scheduling or reserving) on the virtual concierge service 156VC. In some embodiments, usage information may be generated by the user interface module based on information received from the user computing gateway portal 110VC, such as search criteria and requests for purchase. In other embodiments, usage information may be based at least in part on information received from the user computing gateway portals 110VC. For example, user computing devices 110VC may be configured to transmit usage information, such as conducted searches, purchases, etc., to the usage information portal 156VC for further transmission to the usage monitoring module 158VC.

After reception of the usage information by the usage monitoring module 158VC, the usage monitoring module 158VC may, at (3), process the usage information for storage in the usage information data store 166VC. As described above, in some embodiments, processing may include masking of the usage information by removing any personal or sensitive data, such as names, specific addresses, payment information, etc. In some embodiments, masking may include generalization of data. For example, a specific address of a user may be generalized to a corresponding city, region, zip code, area, etc., while removing reference to the user's own address. Still further, in some embodiments, usage information may be compressed or otherwise transformed for future storage in the usage information data store 166VC.

In some embodiments, the usage monitoring module may be further configured to categorize the usage information prior to storage. Categories may be based, for example, on the specific goods and/or service item query, on the user making the request, or on other actions taken by the user. For example, a query for a television provider service with 20 televisions may be categorized as a query by a business user. In the instance where the specific user frequently acquires goods and/or service items through the virtual concierge service 156VC, the query may be categorized as conducted by an “preferred” user. Conversely, a query for a television provider for one television service would be a personal user. Any number of categories may be utilized, including, but not limited to, business users, personal users, preferred users, or and set or subset of labeling of users. In addition, categories may be combined.

Categorization of usage information, such as conducted searches and purchase of goods and/or service items, may be based on the specific query that resulted in the usage (Example, the query that facilitated the search, or the query that ultimately lead to purchase of a goods and/or service item). Aspects of a query that may be utilized in order to categorize a given usage include, but are not limited to, the number of users searched for, the number of services, the time and date of service, the length of service contract, the provider or brand requested (Example, restaurant chain, grocery chain, television provider, etc.), the location of service.

Categorization of usage information may further be based on activity of the user or profile data of the user. For example, a user that has recently conducted a large number of searches over a span of many days for large scale services may be more likely to be classified as a business user (Example, if the recent activity indicates a desire to purchase in bulk multiple or expensive items). Conversely, a user who searches for a single product and acquires a goods and/or service item relatively quickly may be more likely to be classified as a personal user (Example, if the user shops for and buys one gallon of milk). In some embodiments, profile data of a user may further be used to classify activity by the user. For example, where purchase history indicates repeated purchases of bulk items to the same location, the user's activity may be more likely to be classified as business activity. Similarly, where purchase history indicates one-time low volume purchases, activity of the user may be more likely to be categorized as personal.

Accordingly, in accordance with embodiments of the present invention, the usage monitoring module 158VC may be configured to, at (4) categorize each item of usage information (Example, each submitted search query or goods and/or service item purchase) into one or more categories based on the activity itself, such as the submitted query that resulted in a given search or goods and/or service item purchase. By collection of usage information into one or more categories, the virtual concierge service 156VC may be enabled to provide future users with information specifically targeted to their needs. For example, a user submitting a “business” category query may be presented with assertions or other information based on other “business” activity. Still further, collection of usage information into one or more categories may facilitate rapid selection of relevant usage information (Example, for the creation of assertions) by reducing the amount of usage data returned.

After processing and categorization of the usage information, such usage information may be transmitted at (5) to the usage information data store 164VC for storage. As will be described in more detail below, such usage information may be utilized by other aspects of the virtual concierge platform 156VC such as the assertion discover module 160VC FIG. 2, in order to generate assertions for presentation to user computing devices.

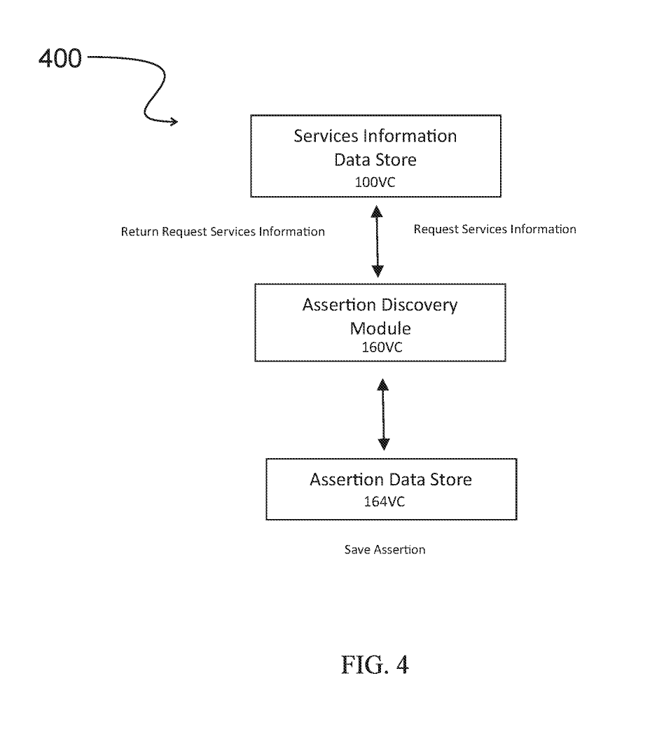

With reference now to FIG. 4, an illustrative interaction for generation of assertions based on usage information within the usage information data store 164VC will be described. The interaction of FIG. 4 may be carried out, for example, subsequent to the interaction of FIG. 3. Specifically, at (1), the assertion discovery module 160VC of FIG. 4 may request usage information from the usage information data store 100VC. In response, at (2), the usage information assertion data store 164VC FIG. 4 may return the usage information to the assertion discovery module 160VC FIG. 4.

In some embodiments, the assertion discovery module 160VC may be configured to limit the amount of usage information retrieved. Illustratively, the assertion discovery module 160VC may limit the retrieved usage information to user activities over a specific past period of time (Example, a calendar month). By limiting retrieved usage information, the relevance of assertions generated based on the usage information may be increased. Further, by limiting the retrieved usage information, the computation power required by the assertion discovery module 160VC may be reduced.

Thereafter, at (3), the assertion discovery module 160VC may generate one or more assertions based on the usage information. As described above, assertions may generally be associated with search criteria or a collection of search criteria. For example, assertions may be created corresponding to a query for bundled services on a specific date. As a further example, assertions may be created for a set of search criteria. Illustratively, assertions may be created for all queries for unbundled one item as of a specific date. In some embodiments, generation of assertions may include conducting data analysis of all usage data corresponding to a given set of search criteria, in order to identify any activity shared among more than a threshold number of users. In some embodiments, such thresholds may be percentage based (Example, any activity conducted by more than a given percentage of users). In other embodiments, such thresholds may be absolute values (Example, any activity conducted by more than a given number of users). For example, in some embodiments, the assertion discovery module 160VC may sort all usage information corresponding to a specific set of search criteria based on assertion types (Example, alternate or more specific dates, specific items selected, brand name vs. generic, provider, etc.) to determine any collection of user activity which exceeds the given threshold. Therefore, an assertion may be created indicating the amount or percentage of users buying a bundled service. Accordingly, by analyzing usage information pertinent to a specific set of search criteria, the most relevant assertions corresponding to the set of search criteria may be located and generated.

As described above, in some embodiments, assertions may further be based on a categorization of the usage information. Accordingly, where usage information has been categorized, the assertion discovery module 160VC may be configured to generate assertions specific to each category of usage information. Such category specific assertions may be beneficial, for example, where the activities of different categories of users vary widely. Illustratively, a large proportion of usage information with regard to services in a metro area versus a rural area can determine scope of pricing and other details.

After generation of relevant assertions for a given set of search criteria, the assertion may be stored in the assertion data store 164VC. As will be described below, these assertions may thereafter be retrieved for presentation to a user computing gateway portal 110VC FIG. 3 (Example, in conjunction with results of a query for goods and/or service items).

With reference now to FIG. 2, an illustrative interaction for provision of generated assertions to a user computing gateway portal 110VC based on a goods and/or service item query will be described. Specifically, at (1), a user computing gateway portal 110VC may submit a query for a goods and/or service item to the user interface module 156VC of FIG. 2. In some instances, a submitted query may be explicit. For example, the user computing gateway portal 110VC may specifically request information regarding items matching given criteria. In other instances, a submitted query may be implicit or otherwise inferred (Example, based at least in part on user activity within the virtual concierge service platform 156VC FIG. 3). For example, a user may view information regarding baby cribs for a number of days. In such an instance, it may be that the user is also interested in diapers, toddler clothes, bottles, baby monitors etc. . . . . Accordingly, a query for baby items for purchase, lease or services. may be inferred, and assertions regarding that query may be presented to the user. In some embodiments, an inferred query may be presented to the user. In other embodiments, assertions may be presented to the user without inclusion of the inferred query. Accordingly, though embodiments may be described herein with reference to explicit queries, assertions may be presented based on explicit, implicit, or inferred queries. After receiving or otherwise determining such a query, the user interface module 156VC FIG. 2 may, at (2), submit a request to the assertion discovery module 160VC FIG. 2 for assertions relevant to the user query.

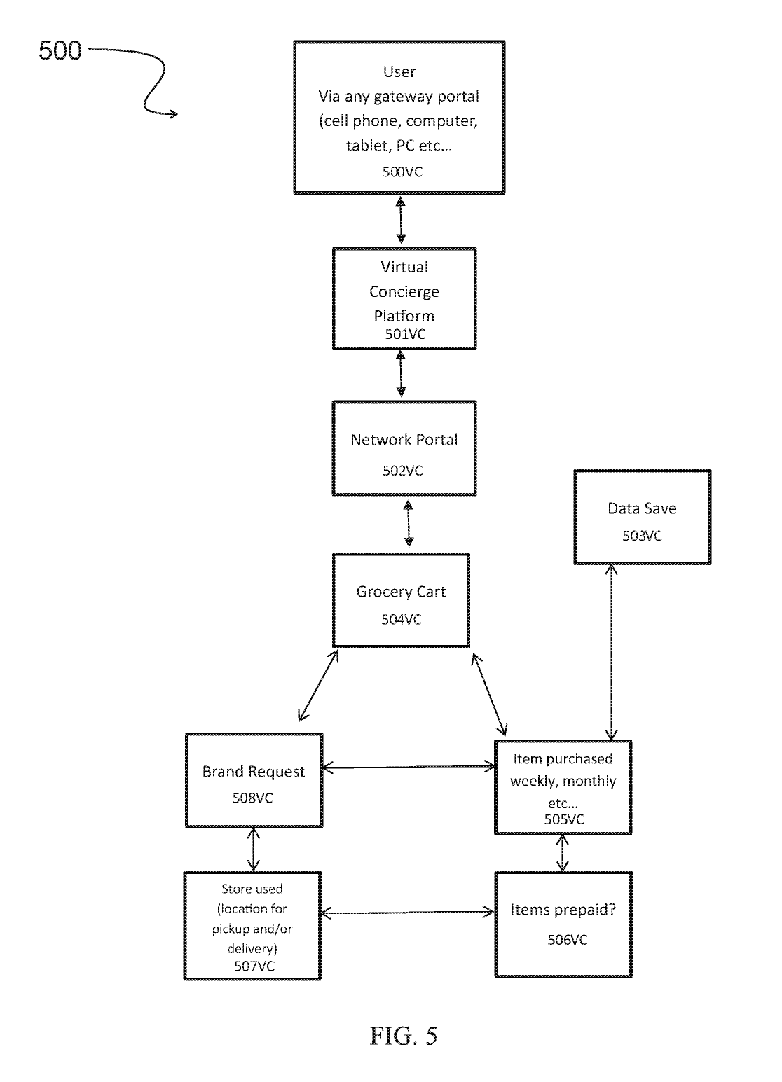

As described above, in some embodiments, assertions may be divided into a number of categories, based on a type of query received, or a type of user making the query. Accordingly, in some embodiments, the assertion discovery module 160VC FIG. 2 may be configured at (3) to determine a category of the query received from the user computing gateway portal 110VC FIG. 2. In general, categorization of a retrieved assertion may be similar to categorization of usage activity. For example, categorization may be based at least in part on the criteria of the received query, on prior activity of the user computing gateway portal 110VC FIG. 2, on profile information of the user (Example, as stored within the user profile data store 166VC FIG. 2), or on any combination thereof. Categorization of a query will be described in more detail with respect to FIG. 5, below.

Thereafter, at (4) the assertion discovery module 160VC FIG. 2 may request relevant assertions from the assertion data store 164VC. In return, the assertion data store 164VC may return the relevant assertions. As described above, assertions may generally correspond to a set of search criteria. For example, a first set of assertions may correspond to searches for baby cribs on Jan. 1, 2015, while a second set of assertions may correspond to searches for cribs in September January, 2015. However, relevance of the set of assertions specific to the queried date may exceed the relevance of the set of assertions for the entire week, month, year etc. . . . in which the purchase would occur. Accordingly, in some embodiments, where multiple sets of assertions are determined to be relevant to a received query, the assertion discovery module 160VC may be configured to determine only a subset of relevant assertions to be presented to the user computing gateway portal 110VC. For example, the assertion discovery module 160VC may be configured to attempt to return only the most relevant assertions to the user computing gateway portal 110VC. Relevance of assertions may be based at least in part on a prioritization of categories or types of assertions. Illustratively, in the example given above, assertions associated with the specific date of purchase queried may be returned prior to assertions associated with the specific months of purchase. In some embodiments, the number of provided assertions may be manually specified. In other embodiments, the number of provided assertions may be specified by the preferences of the user computing gateway portal 110VC. In still more embodiments, the number of provided assertions may be based at least in part on the display capabilities of the user computing gateway portal 110VC (Example, the amount of assertions that are capable of being displayed on one user interface screen).

After determining a set or subset of relevant assertions, the assertion discovery module 160VC may, at (6), return the determined assertions to the user interface module 156VC. The user interface module 156VC may thereafter, at (7), return the relevant assertions to the user computing gateway portal 110VC for presentation to the user. Illustratively, the interaction of FIG. 2 may be performed in conjunction with an interaction to return goods and/or service items relevant to the submitted concierge query. Accordingly, though not shown in FIG. 2, the user interface module 156VC may further transmit goods and/or service items relevant to the user to the user computing gateway portal 110VC. As such, the user may be enabled to view relevant goods and/or service items based on the submitted query, as well as assertions regarding other activity of users based on similar queries. Based on such assertions, the user may be enabled to modify, alter, or expand their submitted query. For example, a user submitting a query for baby cribs in January 2015 may be presented with an assertion that, of other users submitting similar queries, 90% purchased a stroller, baby monitor or like items. Because of the users search criteria, some goods and/or services may not be presented, despite the advantages identified by other users. As will be described in more detail below, by selecting the presented assertion, the user may be enabled to view baby goods and/or services, and therefore to ascertain any advantages in buying baby goods and/or services, that otherwise would not be presented to the user.

Though not shown in FIG. 2, in some embodiments, the assertion discovery module 160VC and/or the user interface module 156VC may be configured to determine additional information regarding assertions, such as an average or lowest price of goods and/or service items. Corresponding to the assertion or another difference between items corresponding to the assertion and items returned by the current query.

In other embodiments, the assertion discovery module 160VC and/or the user interface module 156VC may be configured to determine assertions associated with contacts of the user (Example, contacts of the user on the virtual concierge platform 156VC, on a social networking service, contacts within an address book or other information on the user computer gateway portal 110VC). After determination of such contacts, the assertion discovery module 160VC and/or the user interface module 156VC may determine a sub-set of the assertions which reflect actions taken by such contacts. Such sub-sets of assertions may be presented to the user instead of, or in addition to assertions regarding general users.

FIG. 5 is a block diagram illustrating an operating environment for a virtual concierge service grocery cart according to an embodiment of the present invention. FIG. 5 should be taken as illustrative and not limiting to the present invention. Any user via a gateway portal 500VC may access the virtual concierge platform 501VC to use, order, create a list and or automate the grocery list used for buying grocery items.

The network portal 502VC will take the data input supplied from the user as entered in the gateway portal 500VC. The network portal will communicate to the data save 503VC to find or add data save preferences from prior usage as well as new usage.

The data save 503VC will them communicate to both the network portal 502VC and the Grocery Cart 504VC, to determine and assign items to be purchased or saved to be purchased. The network portal 502VC will find the actual item for sale via data saved, API or other communication network with a service provider as shown in FIG. 1. 130VC. The Grocery cart 504VC will use the data save 503VC to determine what items the customer wants and/or generally purchases.

Purchases of items will be saved by various categories. How often does a user need a certain item is saved in 505VC i.e. does a customer buy milk once a week and/or diapers once a month.

What brand request 508VC can be important to users of goods and products. Many users will be brand specific and always want or require a certain brand i.e. Kraft product over generic products.

Store used 507VC is the location closest or most convenient to the user. Store used 507VC will be used to determine where the user will pick up items or where items will be stored for pick up.

Items prepaid 506VC will house payment information from the customer and determined if the customer wants to prepay for items or pay when the customer picks up items that were stored/saved in the grocery cart 504VC.

Overtime the grocery cart 504VC and Data save 503VC will learn the buying patterns of the customer, creating a real time and pre filled grocery cart 504VC. With machine learning and/or artificial intelligence the grocery cart 504VC will be able to take information from the data save 503VC to automatically fill out and or order groceries the user will want or need.

The combination of brand request 508VC, items purchased 505VC, store used 507VC and items prepaid 506VC will all communicate with the data save 503VC to supply data to the grocery cart 504VC, giving the user the ability to track, deleted, add or modify items in the grocery cart via there gateway portal 500VC.

Still referring to FIG. 5, one illustrative routine 500 for generation of assertions based on usage information will be described. The illustrative routine 400 may be carried out, for example, by the assertion discovery module 160VC of FIG. 2. In some embodiments, the routine 500 may be carried out in real-time, such that assertions may be generated based at least in part on a user's query, and that the generated assertions may be made available immediately or substantially immediately to the querying user. In other embodiments, the routine 500 may be carried out periodically, such as once per day, to generate assertions based on the previous day's usage activity.

Further, in some embodiments, the routine 500 may be carried out with respect to a single search. Still further, in some embodiments, usage information may be divided into a number of categories (Example, for business use, personal use, shopping, service related, entertainment etc. . . . ). In some such embodiments, the routine 500 may be implemented repeatedly for each relevant category.

At block 504VC, usage data relevant to the desired assertion set may be retrieved (Example, from the usage information data store 164VC of FIG. 2). For example, (Shopping Cart feature, to be explained in greater detail later in this document) where assertions are desired specific grocery items purchased every week, month, year, etc. . . . In some embodiments, retrieved usage information may be limited in order to increase potential relevancy, to decrease required computational power, or both. For example, retrieved usage information may be limited to user activities over a specific past period of time (Example, 90 days).

Thereafter, at block 504VC, one or more assertion types may be determined. As described above, in some embodiments, assertion types may be specified manually for each query type. Illustratively, for queries regarding goods and/or service items, assertions types may include either alternative or more specific criteria relating to date, time, delivery location, location of installation etc. Based on the manually specified assertion types, the routine 500 may attempt to determine any relevant usage activity (as reflected in the received usage data) which conforms to the specified type.

In other embodiments, assertion types may be automatically generated based on the aspects of goods and/or service items searched for or purchased. For example, the routine 500 may inspect the usage data for any shared characteristics of a large number of user activities. For example, the usage data may reflect that over a threshold number or percent of activities share a specific characteristic (Example, purchase date, brand purchased, type of service used etc.). Because a large number of activities share such a characteristic, the routine 500 may determine that the characteristic should be included as an assertion type. Illustratively, services (dry cleaner) in or around a specific geographic location may not generally correspond to an assertion type. However, if a significant amount of usage activity indicates that particular service around the specific location are relevant to users, an assertion type may be created for service in or around the location.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the invention.

The steps of a method, process, routine, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “Example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is to be understood with the context as used in general to convey that an item, term, etc. may be either X, Y, or Z, or a combination thereof. Thus, such conjunctive language is not generally intended to imply that certain embodiments require at least one of X, at least one of Y and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the invention. As can be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Detail on the Virtual Concierge Service “Grocery Cart”

“VCS” will offer a Grocery Cart; this cart can manage requests from a user via text, voice, messaging and/or any other form of communication with the “VCS” platform.

Grocery cart will have the ability to create a grocery list for the user, as a user finds or needs an item to be added to the Grocery list the user can tell “VCS”. “VCS” will also have an algorithm built into the Grocery Cart to identify what items are requested on a weekly, monthly etc. basis. Example: If a user requests two gallons of skim milk every week the “VCS” system will automatically update that item to the list weekly. “VCS” will also engage partnerships with various grocery chains to offer services around the shopping cart feature. Services offered will range from home delivery akin to Instacart as well as options to have the user's items stocked in a physical grocery cart ready for pick up as well as items bagged and paid for, so the customer can pick up the items requested at the store and leave without having to shop within the store.

Grocery Cart feature will also have the ability to partners with food producers and producers of other products commonly sold at a grocery store. Through the partnerships “VCS” may be able to offer discounts as well as brand preferences. Example: If a user selects light bulbs and macaroni and cheese as items to be picked up “VCS” may load the customers shopping list with GE light bulbs and Kraft macaroni and cheese due to partnerships between “VCS” and the producer of goods offered. Users will have the option to select in preferences producers (Kraft, GE, Nestle etc. . . . ) and/or cheapest option (Generic, discounted etc. . . . ). If a customer picks the cheapest option GE will have the option to match the stores current lowest priced light bulb or the lowest priced light bulb will be selected.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire invention, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the invention (and in particular, claims) are not used to show a serial or numerical limitation but instead are used to distinguish or identify the various members of the group.

What is claimed is:

1. A computer-implemented method for providing assertions in response to a goods and/or service item query, the method comprising:
as implemented by one or more computing devices configured with specific executable instructions, receiving usage data reflective of user activity on a virtual concierge service, the user activity comprising a plurality of queries for goods and/or service items offered for by the virtual concierge service; for a set of search criteria, determining an assertion based at least in part on the usage data, wherein the assertion is associated with a modified set of search criteria determined based at least in part on a user activity, wherein the user activity is reflective of user action taken in response to a query corresponding to the set of search criteria; receiving, from a user computing device, a query corresponding to the set of search criteria; transmitting the determined assertion to the user computing device; receiving selection of the assertion by the user computing device; automatically modifying the query in accordance with the modified set of search criteria; and transmitting results of the modified query to the user computing device.

2. The computer-implemented method of claim 1, wherein a goods and/or service item corresponds to at least one virtual concierge service.

3. The computer-implemented method of claim 1, wherein the user activity corresponds to at least one of searching for goods and/or service items or acquiring a goods and/or service item.

4. The computer-implemented method of claim 1, wherein modifying the query in accordance with the modified set of search criteria comprising modifying at least one of a package to be selected, a service location, a specific brand, a number of items purchased, a number of users, a preferred level of service, and a preferred provider of the goods and/or service item.

5. The computer-implemented method of claim 1, wherein the determined assertion is further associated with a categorization of the user activity.

6. The computer-implemented method of claim 1, wherein the categorization of the user activity corresponds to at least one of business or personal.

7. A system for providing assertions regarding an item query, the system comprising:
at least one data store configured to store assertions, wherein each assertion is associated with a set of search criteria and with a modification of the set of search criteria determined based at least in part on a user activity, and wherein the user activity is reflective of user action taken in response to a query corresponding to the set of search criteria; and
one or more processors in communication with the at least one data store, the one or more processors configured to: receive, from a user computing device, a query including search criteria; and determine one or more of the assertions corresponding to the query based at least in part on the search criteria; wherein user selection of the determined one or more assertions enables modification of the query based at least in part on the modification associated with the assertion.

8. The system of claim 7, wherein the one or more processors are further configured to transmit the determined one or more assertions to the user computing device.

9. The system of claim 7, wherein the query corresponds to a query for one or more goods and/or service items.

10. The system of claim 7, wherein each of the determined one or more assertions are further associated with a categorization of the user activity corresponding to the assertion.

11. The system of claim 7, wherein the one or more processors are further configured to determine a categorization of the query based at least in part on the search criteria.

12. The system of claim 11, wherein the determination of one or more of the assertions corresponding to the query is further based at least in part on the determined categorization of the query.

13. The system of claim 7, wherein the categorization of the query is further based at least in part on at least one of past activity of the user computing device, a user profile associated with the user computing device, or purchase history of a user associated with the user computing device.

14. The system of claim 7, wherein the user activity corresponds to at least one of searching for an item or acquiring an item.

15. The system of claim 7, wherein the one or more processors are further configured to determine additional information regarding items corresponding to the one or more assertions.

16. The system of claim 7, wherein the additional information comprises at least one of an average price of the items corresponding to the one or more assertions, a lowest price of an item corresponding to the one or more assertions, and a difference in price between an item corresponding to the one or more assertions and an item corresponding to the received query.

17. A non-transitory computer-readable storage medium having at least one computer-executable module for providing assertions regarding an item query, the at least one computer-executable module comprising:
an assertion module configured to: maintain one or more assertions, wherein each assertion is associated with set of search criteria and with a modification of the set of search criteria determined based at least in part on a user activity, and wherein the user activity is reflective of user action taken in response to a query corresponding to the set of search criteria; determine a query including search criteria based at least in part on activity of a user computing device; determine at least one of the one or more assertions corresponding to the query based at least in part on the search criteria; and transmit the determined at least one assertion to the user computing device; wherein user selection of the determined at least one assertion enables modification of the query based at least in part on the modification associated with the assertion.

18. The non-transitory computer-readable storage medium of claim 17, wherein the user activity of each of the one or more assertions corresponds to activity of a contact of the user associated with the user computing device, and wherein the contact corresponds to at least one of a contact on a virtual concierge service, a contact on a social networking service, or a contact within an address book of the user associated with the user computing device.

19. The non-transitory computer-readable storage medium of claim 17, wherein the assertion module is further configured to generate the one or more assertions based on received usage data, and wherein the usage data reflects activity of users taken in response to a query corresponding to the set of search criteria.

20. The non-transitory computer-readable storage medium of claim 19, wherein generation of the one or more assertions comprises a determination of a user activity conducted by users a threshold number of times.

21. The non-transitory computer-readable storage medium of claim 19, wherein generation of the one or more assertions comprises a determination of a user activity conducted by at least a threshold percentage of users in response to a query corresponding to the set of search criteria.

22. A computer-implemented method for providing assertions regarding an item query, the method comprising:
as implemented by one or more computing devices configured with specific executable instructions, determining one or more assertions, wherein each assertion is associated with set of search criteria and with a modification of the set of search criteria determined based at least in part on a user activity, and wherein the user activity is taken in response to a query corresponding to the set of search criteria; determine a query including search criteria based at least in part on activity of a user computing device; and determining at least one of the one or more assertions corresponding to the query based at least in part on the search criteria; wherein user selection of the determined at least one assertion enables modification of the query based at least in part on the modification associated with the assertion.

23. The computer-implemented method of claim 22, wherein determining at least one of the one or more assertions corresponding to the query further comprising determining a prioritization of the one or more assertions corresponding to the query.

24. The computer-implemented method of claim 22, wherein determining one or more assertions is based at least in part on usage data reflective of activities of users taken in response to a query corresponding to the set of search criteria.

25. The computer-implemented method of claim 22 further comprising transmitting the determined one or more assertions to the user computing device.

26. The computer-implemented method of claim 22, wherein the determined query is at least one of an explicit query and an inferred query.
